(19) United States
(12) Patent Application Publication
(10) Pub. No.: US 2009/0265268 A1
(43) Pub. Date: Oct. 22, 2009

(54) METHOD AND SYSTEM FOR MATCH MAKING IN VIRTUAL CURRENCY EXCHANGE

(75) Inventors: Ying Huang, Yorktown Heights, NY (US); Hui Su, Beijing (CN); Jian Wang, Beijing (CN); Li Wang, Beijing (CN); Nai Chi Yu, Taipai (TW); Jun Zhu, Beijing (CN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/104,549

(22) Filed: Apr. 17, 2008

(51) Int. Cl. G06Q 40/00

(52) U.S. Cl. 705/39

(57) ABSTRACT

A method, system and computer program product are disclosed for matching virtual currency exchange requests. The method comprises the step of creating a virtual currency exchange network comprised of a set of nodes and a set of edges connecting the nodes together. Each of the nodes represents a virtual currency type, each of the edges represents a virtual currency exchange request, and one of the edges represents a current virtual currency exchange request. A plurality of paths are identified in the network as potentially fulfilling the current virtual currency exchange request. Each of these paths is comprised of at least two edges of the network, and each of the paths represents one way to fulfill the current virtual currency exchange request. One of those paths is selected, using a defined set of criteria, as an optimal path for fulfilling said current virtual currency exchange request.

### BACKGROUND OF THE INVENTION

1. Field of the Invention

This invention generally relates to virtual economies, and more specifically, to virtual currency exchange.

2. Background Art

Virtual economies are economies in virtual persistent worlds, typically Internet games. Virtual economies are emerging as important aspects of many Internet games and are actually becoming linked with the real world in that players will use real money to buy and sell virtual assets.

Many business entities issue various network virtual currencies (VCs) to motivate customers and increase their loyalty, such as Airchina Mileage, Chine Mobile Point and so on. Many Internet game operators also issue many kinds of virtual currencies to use as common currencies in game worlds. Their purposes are to play as the virtual payment means. Famous game currencies in China have QQ coins, Shanda coins, Moshou coins, Baidu coins and so on. Actually, current network virtual currencies have been widely used in the Internet, for example, they are used to exchange gifts, services, flight tickets, even as the salary paid to the BBS board owner. The American well-known economist, Clinton LaRouche has a prediction which describes the future virtual economy: “within the daily global financial transactions, only 2% are related to real economy. From 2050, web-based virtual currency will be officially recognized to some extent, and become liquid common currency.” Network virtual currency market is becoming bigger and bigger. There are many business opportunities in this area.

Although there are more and more virtual currencies emerging, few of them can be exchanged with each other via official exchange channels. However, end users have strong need to exchange these currencies from one virtual currency to another virtual currency. Considering the potential legal constraint—virtual currencies cannot be exchanged to real money—a direct VC-to-VC exchange platform (marketplace) may be a better solution for the user requirement. One common VC-to-VC exchange platform (marketplace) can have the following structure shown in FIG. 1.

In the system 100 of FIG. 1, users submit VC exchange requests, represented at 102, to a pool 104 via a virtual portal 106. A matching engine 110 then matches the currency request. The transactions are managed by a transaction manager 112, and user accounts 114 are credited and debited accordingly.

In the platform, users can submit VC exchange requests to the marketplace, which may include the following information: source currency type and expected exchange amount, target currency type and expected amount in target currency type, and other additional requirements/constraints. A current, difficult problem to be solved is how to provide an effective and efficient mechanism to support transaction matching given a VC exchange request pool. Solving this problem will be a key challenge to making a successful, valuable VC exchange solution.

### SUMMARY OF THE INVENTION

An object of this invention is to provide an effective and efficient mechanism to support transaction matching from a virtual currency exchange request pool.

Another object of the present invention is to find a group of optimal transactions from an existing virtual currency exchange request pool to fulfill a virtual currency exchange request.

A further object of the invention is to organize and index virtual currency exchange requests, to group potentially related or indirectly related requests together, and to design an optimal transaction to fulfill those exchange requests.

These and other objectives are attained with a method, system and computer program product for matching virtual currency exchange requests. The method comprises the step of creating a virtual currency exchange network comprised of a set of nodes and a set of edges connecting the nodes together. In this network, each of the nodes represents a virtual currency type, each of the edges represents a virtual currency exchange request, and one of the edges represents a current virtual currency exchange request. A plurality of paths is identified in the network as potentially fulfilling the current virtual currency exchange request. Each of these paths is comprised of at least two edges of the network, each of the paths starts at and finishes at one of the nodes, and each of the paths represents one way to fulfill the current virtual currency exchange request. One of those paths is selected, using a defined set of criteria, as an optimal path for fulfilling said current virtual currency exchange request.

In a preferred embodiment of the invention, the paths are prioritized according to a given set of transaction priority rules. More specifically, the paths are ranked according to said transaction priority rules, and the first path in this ranking is selected as the optimal path. Also, in this preferred embodiment, the transaction priority rules are based on exchange rates and transaction amounts for each of the paths, and the network may be reiteratively looked at several until at least one path is identified that fulfills the current virtual currency exchange request.

The preferred embodiment of the invention, described in detail below, provides a method and apparatus to support high-efficient automatic match making for both bilateral and multilateral virtual currency exchange, in which the matching priority policies are configurable. As one application scenario, the invention can be used in the match engine in FIG. 1. The invention may also be used as a critical component to enable the VC-to-VC exchange platform (marketplace).

This invention has some similarities to the Foreign eXchange Transaction System (FXTS), http://www.qdcaijing.com/content/2006-01/04/content_{—}5813007.htm).

There are a number of important differences between virtual currency exchange and real currency exchange. For instance, with virtual currency exchange, there is no baseline exchange rate, and it is hard to get a baseline exchange rate because no organization functions as a bank does in the FXTS. In contrast, with real currency exchange, there is a baseline exchange rate, and the existence of this rate makes the exchange easier. In virtual currency exchange, there is no medium currency, which makes exchange more difficult. In real currency exchange, the US dollar is the medium of exchange. Each non-US dollar currency will have an exchange rate against the US dollar. The generation mechanisms of exchange rate can have various modes, such as OTC mode among banks and matching mode among banks. The matching mode among banks will only cover bilateral matching.

Also, the exchange participants in a virtual currency exchange are different than the exchange participants in a real currency exchange. Virtual currency exchanges happen among two or multiple end-users, and no organization functions as a bank like in FXTS. In comparison, real foreign exchange transactions happen between individuals and banks. The transactions are based on a baseline exchange rate, which can be generated according to various modes such as, as mentioned above, OTC mode among banks, and matching mode among banks.

With virtual currency exchanges, whether the exchange amount in one request can be fulfilled depends on the users' provision on the needed currency type. It may be the case that one exchange request can be fully or partially fulfilled by one or many other requests or compound requests. In contrast, with real currency exchange, any amount from users can be fulfilled by banks.

Virtual currency exchanges, in comparison with real currency exchanges, have priority and additional constraints in matching. With virtual currency exchanges, there are complex priority issues and additional various constraints during the match procedure, and this makes the matching mechanism more complex. For example, some exchanges may only be allowed for certain, VIP customers, and some exchanges are only allowed for certain periods of time or in certain time periods. Also, when there are two different exchange paths that can fulfill one request, these two paths may have different priorities. The priorities may be different in different situations according to the demands of different operations of the VC exchange platform. With real currency exchange, there are no priority issues or additional constraints in inter-bank matching.

In addition, there are many multilateral currency exchanges in the virtual currency world, while there are no multilateral exchange issues in the real currency exchange world. In the real currency exchange world, there are only bilateral issues. In the virtual currency world, one exchange request can often by fulfilled by multiple, different exchange rates; while in the real currency world, one exchange request can only be fulfilled under a single exchange rate. Also, the time of exchange may be different in the virtual currency world than in the real currency world. In the virtual currency world, an exchange request may be fulfilled over multiple, different time points, while a real currency exchange request is fulfilled at one time point.

According to the comparison above, it is clear that the transaction mechanism in FXTS cannot apply to virtual currency exchange, either for bilateral or multilateral exchanges.

The invention provides a mechanism to help a user find a group of optimal transactions from an existing VC exchange request pool to fulfill his/her VC exchange request. The optimal transaction group may include one or multiple exchange paths. An exchange path can include one or multiple exchange steps, (i.e. one exchange path can be bilateral or multilateral). The mechanism in the preferred embodiment of the invention includes the following key points:

(1) Basing on existing exchange requests, a local exchange network is created for a current VC exchange request to accelerate request searching and loop identification;
(2) Identify all potential counter-exchange path by VC type to get a list of counter-exchange paths;
(3) Compute the maximum exchangeable amount and exchange rate for each path;
(4) Evaluate each path's exchangeable amount and rate against the current request to find a list of exchangeable counter paths, and then prioritize all exchangeable paths based on pre-configured transaction priority rules; and
(5) Select the first prioritized counter-path as the found exchange path. If this counter path can completely fulfill the current request or no such counter-path exists, then the algorism is done. Finally, a group of prioritized exchange paths is generated. Otherwise, update the existing counter-exchange paths, and go to (2) to continue.

The preferred embodiment of the invention has a number of important advantages, including the following:
(1) In multilateral exchange scenarios, it is difficult for a VC exchange requester to directly find the suitable partners to exchange with. It is also more difficult for VC exchange requesters to find a best way or optimal way to fulfill their requirements through exchange. The preferred embodiment of the invention can help a user find the optimal transaction way from other existing exchange requests according to the user's exchange request;
(2) Matching priority policies are configurable and customized;
(3) Dynamical transaction path selection, dynamical transaction amount calculation and dynamical exchange network updating will make sure that the final transaction group is optimal;
(4) A local exchange network is created at the beginning as an index for the whole process. This exchange network accelerates request searching and loop identification; and
(5) There is no need for using a medium currency (especially no need to involve real money as a medium), avoiding potential legal risk.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a virtual currency-to-virtual currency exchange platform.

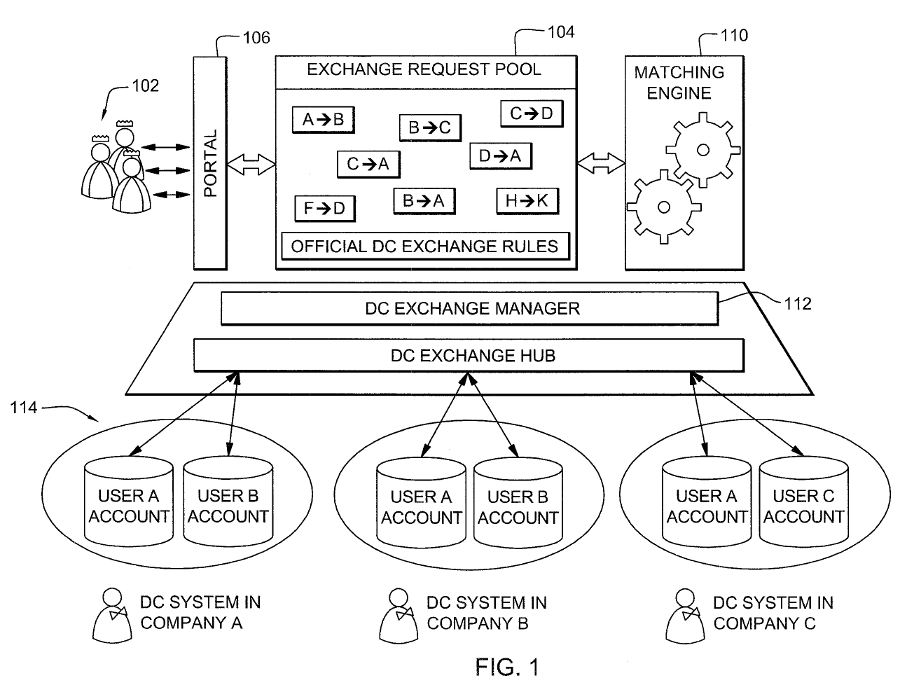

FIG. 2 shows a virtual exchange procedure embodying the present invention.

FIG. 3 is a graph showing potential counter-exchange paths for fulfilling a virtual currency exchange request.

FIG. 4 illustrates the step of computing the maximum exchangeable and exchange rate for each path.

FIG. 5 illustrates the step of evaluating each path's exchangeable amount and rate against an exchange request.

FIG. 6 illustrates the step of selecting a first priority counter-path according to a defined priority.

FIG. 7 shows a computing environment in which the present invention may be implemented.

### DETAILED DESCRIPTION OF THE PREFERRED EMBODIMENTS

The invention provides a mechanism and device that can organize and index the user's virtual currency exchange requests, group the potentially related or indirectly related request together and design an optimal transaction way for the users to fulfill their VC exchange requests. The invention also enables the operator of the apparatus to configure the matching policies to influence the prioritization in the matching procedure.

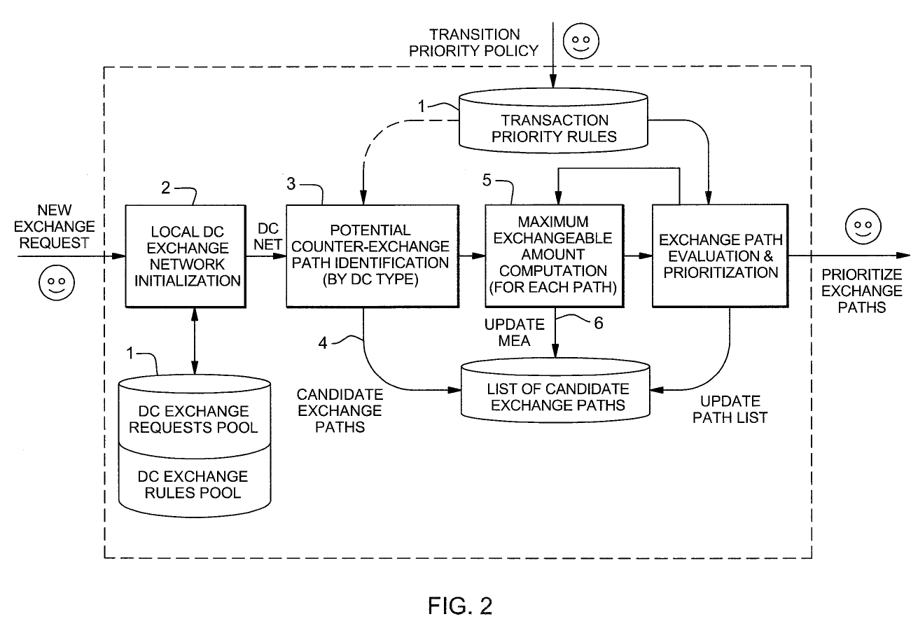

FIG. 2 illustrates a procedure embodying a preferred embodiment of the invention. Generally, in this procedure, at step 1, some VC exchange requests and official exchange rules are input into the exchange system; and at step 2, a local VC exchange network is initialized for a new request R0. Step 3 is to identify all potential counter-exchange paths by VC type, and step 4 is to compute the maximum exchangeable amount and exchange rate for each path. At step 5, each path's exchangeable amount and rate are evaluated against R0; and at step 6, a first priority counter-path is selected. Each of these steps is discussed in more detail below.

At step 1, some VC exchange requests and official exchange rules have been input into VC exchange request pool 202. Transaction priority rules have also been pre-configured at 204. Sample priorities are listed below in an order of decreasing priority:
1. By actual transaction happen rate;
2. By actual transaction happen amount:
3. By requesters' membership;
4. By request time
5. By transaction fee
6. and so on.

Some transaction constraints will also be defined. For example, certain exchange can only happen for a VIP user or in a special time period.

Step 2 is to initialize local VC exchange network for a new request R0.

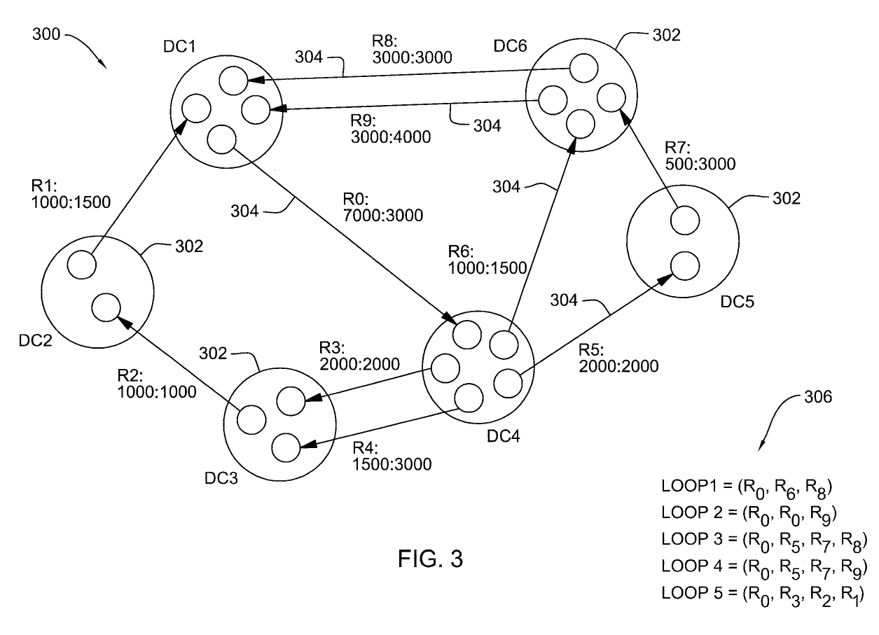

In this step, with reference to FIG. 3, all reachable requests and virtual currency types from R0 are found from the request pool to compose a network/graph like the one shown at 300 in FIG. 3. The network is made up of a set of VC types as nodes 302, which can be reached from the target currency of current request via other existing requests, and a set of exchange requests as edges 304 connecting VC types. One request includes the following attributes: source currency type, source exchange amount, target currency type, expected target exchange amount or rate.

During selection, the transaction constraints will be checked, and only requests that meet those constraints can be added as edges of the graph.

Step 3 is to identify all potential counter-exchange paths by VC type to get a list of counter-exchange paths. If no scan path exists, the algorism is finished.

With reference to FIG. 3, this step does matching from VC type perspective. Because this step seeks all loops including R0, the step is referred to as “loop-shape match making”. FIG. 3 also shows a group of loops 306 identified in this step.

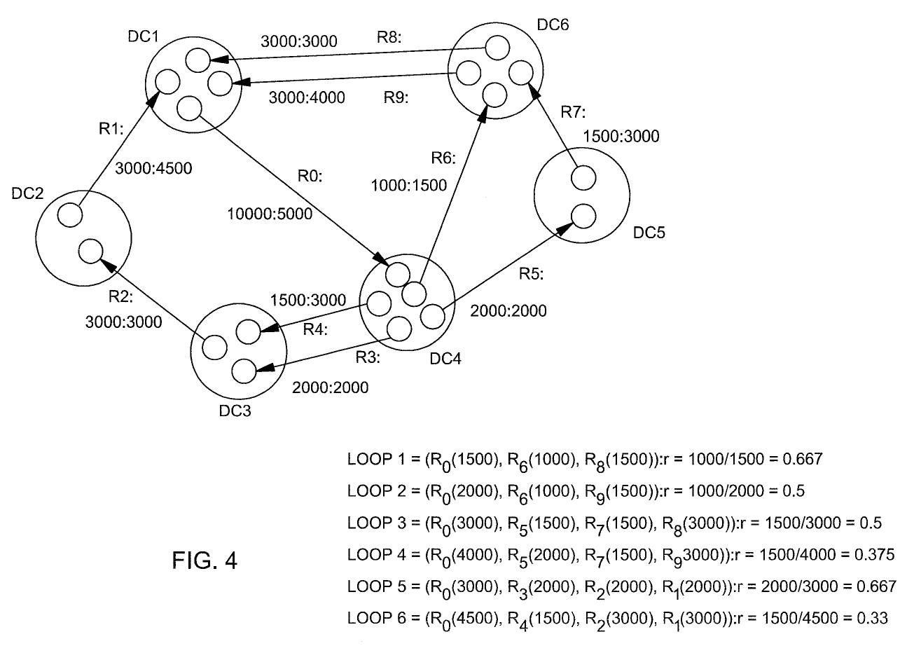

Step 4 is to compute maximum exchangeable amount and exchange rate for each path. In this step, illustrated in FIG. 4, any suitable algorithm may be used to calculate an exchange path's maximum exchangeable amount and exchange rate.

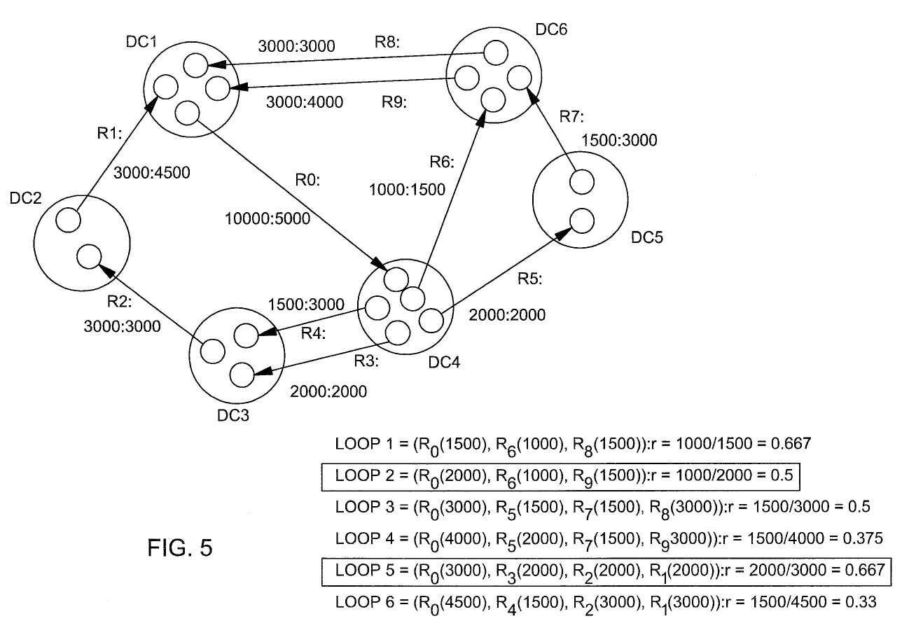

As illustrated in FIG. 5, step 5 is to evaluate each path's exchangeable amount and rate against R0 to find a list of exchangeable counter paths, and then to prioritize all exchangeable paths based on pre-configured Transaction Priority Rules. If the list is empty, then the algorism is finished.

This step does matching from VC rate and amount perspective. Because R0 is considered as the exchange center to do rate and amount match making, this step is referred to as “star-shape match making”.

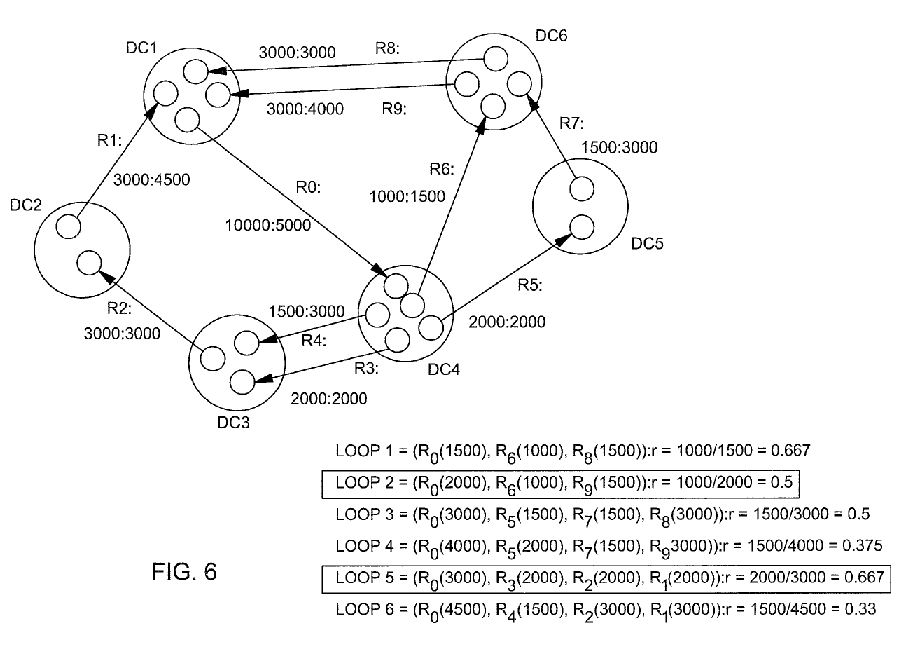

Step 6, represented in FIG. 6, is to select the first priority counter-path according to the exchange priority policy defined in step 0. If no such counter path exists, or this counter path can completely fulfill R0, then the algorism is over. Otherwise, the list of counter-exchange paths is updated, and the algorithm returns to Step 2 and proceeds from there. This is an iterative process because some originally available paths may have become unavailable or their exchangeable currency amount decreased due to some critical requests may be consumed by the first priority counter-path.

The method of the present invention will be generally implemented by a computer executing a sequence of program instructions for carrying out the steps of the method and may be embodied in a computer program product comprising media storing the program instructions. For example, FIG. 6 and the following discussion provide a brief general description of a suitable computing environment in which the invention may be implemented. It should be understood, however, that handheld, portable, and other computing devices of all kinds are contemplated for use in connection with the present invention. While a general-purpose computer is described below, this is but one example, the present invention may be implemented in an environment of networked hosted services in which very little or minimal client resources are implicated, e.g., a networked environment in which the client device serves merely as a browser or interface to the World Wide Web.

Although not required, the invention can be implemented via an application-programming interface (API), for use by a developer, and/or included within the network browsing software, which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments.

Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 6, thus, illustrates an example of a suitable computing system environment 600 in which the invention may be implemented, although as made clear above, the computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

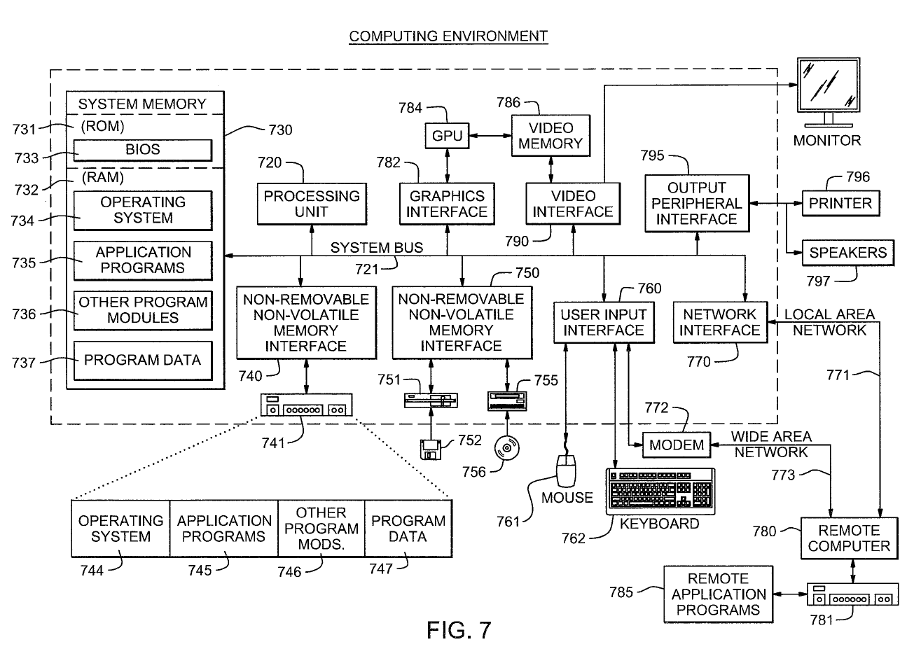

With reference to FIG. 7, an exemplary system for implementing the invention includes a general purpose-computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 710.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7 provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies.

A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus 721, but may be connected by other interface and bus structures, such as a parallel port, game port or a universal serial bus (USB).

A monitor 791 or other type of display device is also connected to the system bus 721 via an interface, such as a video interface 790. A graphics interface 782, such as Northbridge, may also be connected to the system bus 721. Northbridge is a chipset that communicates with the CPU, or processing unit 720, and assumes responsibility for accelerated graphics port (AGP) communications. One or more graphics processing units (GPUs) 684 may communicate with graphics interface 782. In this regard, GPUs 684 generally include on-chip memory storage, such as register storage and GPUs 784 communicate with a video memory 786. GPUs 784, however, are but one example of a coprocessor and thus a variety of co-processing devices may be included in computer 710. A monitor 791 or other type of display device is also connected to the system bus 721 via an interface, such as a video interface 790, which may in turn communicate with video memory 786. In addition to monitor 791, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 660, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

One of ordinary skill in the art can appreciate that a computer 710 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of matching virtual currency exchange requests, comprising the steps of:
creating a virtual currency exchange network, the network comprising a set of nodes and a set of edges connecting the nodes together, each of the nodes representing a virtual currency type, each of the edges representing a virtual currency exchange request, and one of the edges representing a current virtual currency exchange request;
identifying a plurality of paths in the network, each of said paths comprised of at least two edges of the network, each of the paths starting at and finishing at one of the nodes, and each of said paths representing one way to fulfill said current virtual currency exchange request; and
selecting one of said paths, using a defined set of criteria, as an optimal path for fulfilling said current virtual currency exchange request.

2. A method according to claim 1, wherein the selecting step includes the step of prioritizing said paths according to a given set of transaction priority rules.

3. A method according to claim 2, wherein:
the prioritizing step includes the step of ranking said paths according to said transaction priority rules; and
the selecting step includes the further step of selecting the first of the paths in said ranking.

4. A method according to claim 2, wherein said transaction priority rules are based on exchange rates and transaction amounts for each of the paths.

5. A method according to claim 1, wherein the identifying step includes the step of repeating the identifying step until at least one path is identified that fulfills said current virtual currency exchange request.

6. A method according to claim 1, wherein the selecting step includes the step of eliminating one or more of the paths that do not satisfy one or more given constraints.

7. A method according to claim 1, wherein the selecting step includes the step of evaluating each path's exchangeable amount and rate against the current virtual currency exchange request.

8. A method according to claim 1, wherein the identifying step includes the step of identifying all of the paths in the network that potentially satisfy said current virtual currency exchange request.

9. A method according to claim 1, wherein the selecting step includes the step of computing a maximum exchangeable amount for each of the identified paths.

10. A method according to claim 9, wherein the selecting step includes the further step of computing a maximum exchange rate for each of the identified paths.

11. A system for matching virtual currency exchange requests, comprising:
a pool of virtual currency exchange requests and transaction rules, said currency exchange requests including a current virtual currency request;
a network initializer for creating a virtual currency exchange network from said virtual currency exchange requests, the network comprising a set of nodes and a set of edges connecting the nodes together, each of the nodes representing a virtual currency type, each of the edges representing one of the virtual currency exchange requests, and one of the edges representing said current virtual currency exchange request;
a path identifier for identifying a plurality of paths in the network, each of said paths comprised of at least two edges of the network, each of the paths starting at and finishing at one of the nodes, and each of said paths representing one way to fulfill said current virtual currency exchange request; and
a matching engine for selecting one of said paths, using a defined set of criteria, as an optimal path for fulfilling said current virtual currency exchange request.

12. A system according to claim 11, wherein the matching engine ranks said paths according to a defined set of transaction priority rules, and selects the first of the paths in said ranking as said optimal path.

13. A system according to claim 11, wherein the path identifier looks a plurality of times for paths that satisfy said current virtual currency exchange request until at least one path is identified that fulfills said current virtual currency exchange request.

14. A system according to claim 11, wherein the matching engine eliminates one or more of the paths that do not satisfy one or more given constraints, and evaluates each path's exchangeable amount and rate against the current virtual currency exchange request.

15. A system according to claim 11, wherein the matching engine computes a maximum exchangeable amount for each of the identified paths and computes a maximum exchange rate for each of the identified paths.

16. An article of manufacture comprising
at least one computer usable medium having computer readable program code logic to execute a machine instruction in a processing unit for matching virtual currency exchange requests, said computer readable program code logic when executing performing the following steps:
creating a virtual currency exchange network, the network comprising a set of nodes and a set of edges connecting the nodes together, each of the nodes representing a virtual currency type, each of the edges representing a virtual currency exchange request, and one of the edges representing a current virtual currency exchange request;
identifying a plurality of paths in the network, each of said paths comprised of at least two edges of the network, each of the paths starting at and finishing at one of the nodes, and each of said paths representing one way to fulfill said current virtual currency exchange request; and
selecting one of said paths, using a defined set of criteria, as an optimal path for fulfilling said current virtual currency exchange request.

17. An article of manufacture according to claim 16, wherein the selecting step includes the step of prioritizing said paths according to a given set of transaction priority rules.

18. An article of manufacture according to claim 16, wherein the identifying step includes the step of repeating the identifying step until at least one path is identified that fulfills said current virtual currency exchange request.

19. An article of manufacture according to claim 16, wherein the identifying step includes the step of identifying all of the paths in the network that potentially satisfy said current virtual currency exchange request.

20. An article of manufacture according to claim 16, wherein the selecting step includes the steps of computing a maximum exchangeable amount for each of the identified paths, and computing a maximum exchange rate for each of the identified paths.
